(19) United States
(12) Patent Application Publication
(10) Pub. No.: US 2026/0003445 A1
(43) Pub. Date: Jan. 1, 2026

(54) Stylus and stylus control circuit for spin detection

(71) Applicant: NOVATEK Microelectronics Corp., Hsin-Chu (TW)

(72) Inventors: Yu-Ying Tang, Taoyuan City (TW); Chih-Chang Lai, Taichung City (TW)

(73) Assignee: NOVATEK Microelectronics Corp., Hsin-Chu (TW)

(21) Appl. No.: 19/015,530

(22) Filed: Jan. 9, 2025

Related U.S. Application Data
(60) Provisional application No. 63/664,738, filed on Jun. 27, 2024.

(51) Int. Cl. G06F 3/0354; G06F 3/038

(52) U.S. Cl. CPC G06F 3/03545; G06F 3/0383

(57) ABSTRACT

A stylus includes a plurality of transmission electrodes, which include a first transmission electrode and a second transmission electrode. The first transmission electrode is deployed at a first side of a pen axis of the stylus. The second transmission electrode is deployed at a second side of the pen axis of the stylus. The first side is different from the second side.

### CROSS REFERENCE TO RELATED APPLICATIONS

This application claims the benefit of U.S. Provisional Application No. 63/664,738, filed on Jun. 27, 2024. The content of the application is incorporated herein by reference.

### BACKGROUND OF THE INVENTION

### 1. Field Of The Invention

The present invention relates to a stylus and a related stylus control circuit, and more particularly, to a stylus and a related stylus control circuit capable of spin detection.

### 2. Description Of The Prior Art

An active stylus is a common peripheral device used for an electronic device having a touch panel, such as a mobile phone or laptop. In general, the active stylus includes a tip electrode and a ring electrode capable of emitting downlink signals to the touch panel. The control circuit of the touch panel may determine the writing trajectory according to the position of the stylus.

However, a conventional active stylus may not be able to detect the spin of the active stylus; that is, the pen axis rotation is not detectable by the touch panel. In the prior art, an active stylus may be equipped with an additional detecting device (e.g., a gyroscope) to realize the function of pen axis rotation detection. The detecting device requires additional hardware costs and complicates the stylus detect operations.

### SUMMARY OF THE INVENTION

It is therefore an objective of the present invention to provide a novel stylus with an appropriate design of transmission electrodes, in order to realize spin detection without the usage of a gyroscope.

An embodiment of the present invention discloses a stylus. The stylus comprises a plurality of transmission electrodes, which comprise a first transmission electrode and a second transmission electrode. The first transmission electrode is deployed at a first side of a pen axis of the stylus. The second transmission electrode is deployed at a second side of the pen axis of the stylus. The first side is different from the second side.

Another embodiment of the present invention discloses a stylus control circuit for detecting a stylus. The stylus comprises a first transmission electrode and a second transmission electrode. The stylus control circuit receives a first signal distribution corresponding to a first signal output by the first transmission electrode, receives a second signal distribution corresponding to a second signal output by the second transmission electrode, and detects a spin of the stylus according to the first signal distribution and the second signal distribution.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of detection of an active stylus performed by a touch panel.

FIG. 2 is a schematic diagram of a stylus according to an embodiment of the present invention.

FIG. 3 is a schematic diagram of another stylus according to an embodiment of the present invention.

FIG. 4 is a schematic diagram of a stylus control system according to an embodiment of the present invention.

FIGS. 5A-5D illustrate that the stylus standing on the touch panel rotates to generate different signal distributions according to an embodiment of the present invention.

FIGS. 6A-6D illustrate that the stylus hovering on the touch panel rotates to generate different signal distributions according to an embodiment of the present invention.

FIG. 7 and FIG. 8 illustrate the detection of the stylus performed using different frequencies according to embodiments of the present invention.

FIG. 9 and FIG. 10 illustrate the detection of the stylus performed using different timing according to embodiments of the present invention.

FIG. 11 illustrates the detection of the stylus performed using different frequencies according to an embodiment of the present invention.

FIG. 12A illustrates the detection of the stylus performed using different timing according to an embodiment of the present invention.

FIG. 12B illustrates the detection of the stylus performed using different timing with different frequencies according to an embodiment of the present invention.

FIG. 13 is a schematic diagram of a stylus according to an embodiment of the present invention.

FIG. 14 is a schematic diagram of another stylus according to an embodiment of the present invention.

FIG. 15 is a schematic diagram of a stylus according to an embodiment of the present invention.

FIG. 16 is a schematic diagram of deployment of touch sensing electrodes on a touch panel applying the self-capacitive touch sensing.

FIG. 17 is a schematic diagram of deployment of touch sensing electrodes on a touch panel applying the mutual capacitive touch sensing.

FIG. 18 is a schematic diagram of a stylus with a control scheme according to an embodiment of the present invention.

FIG. 19 is a schematic diagram of another stylus with a control scheme according to an embodiment of the present invention.

### DETAILED DESCRIPTION

FIG. 1 is a schematic diagram of detection of an active stylus 10 performed by a touch panel 100. The touch panel 100 (or its control circuit) may detect the active stylus 10 by receiving downlink signals from the active stylus 10. The active stylus 10 may include transmission electrodes TX1 and TX2 on its pen head or pen body, and the transmission electrodes TX1 and TX2 are used for emitting the downlink signals (and/or also receiving uplink signals). In this example, the transmission electrode TX1 is deployed on the pen tip, which may be referred to as a tip electrode, and the transmission electrode TX2 is deployed to surround the pen body, which may be referred to as a ring electrode. The touch panel 100 may detect the position of the active stylus 10 by determining the coordinate of the transmission electrode TX1, and also detect the tilt angle of the active stylus 10 by determining the relative position and distance of the transmission electrodes TX1 and TX2.

For example, as shown in FIG. 1, the tip of the transmission electrode TX1 is projected on the coordinate point X1, and the center of the transmission electrode TX2 is projected on the coordinate point X2, where the distance between X1 and X2 is d. In addition, the distance between the pen tip of the transmission electrode TX1 and the center of the transmission electrode TX2 is equal to r. Therefore, the tilt angle 0 of the active stylus 10 may be calculated as θ=sin⁻¹(d/r).

However, the deployment of transmission electrodes in the active stylus 10 cannot detect the spin/rotation operation. In order to detect the spin (or called pen axis rotation) of a stylus (e.g., active stylus), the present invention provides an arrangement of transmission electrodes for the stylus, where two transmission electrodes may be deployed at different sides of the pen axis of the stylus, so as to perform spin detection through these two transmission electrodes. For example, among those transmission electrodes deployed on the stylus, a first transmission electrode may be deployed at a first side of the pen axis, and a second transmission electrode may be deployed at a second side of the pen axis, where the second side is different from the first side. The pen axis of the stylus refers to an axis connecting the tip of the stylus and the back end of the stylus.

Different from the transmission electrodes TX1 and TX2 in the active stylus 10 of which the relative position is parallel to the pen axis, the transmission electrodes used for spin detection according to the present invention may have a relative position vertical to the pen axis. Therefore, the relative position of these two transmission electrodes may change in response to the spin of the stylus, thereby realizing the spin detection function.

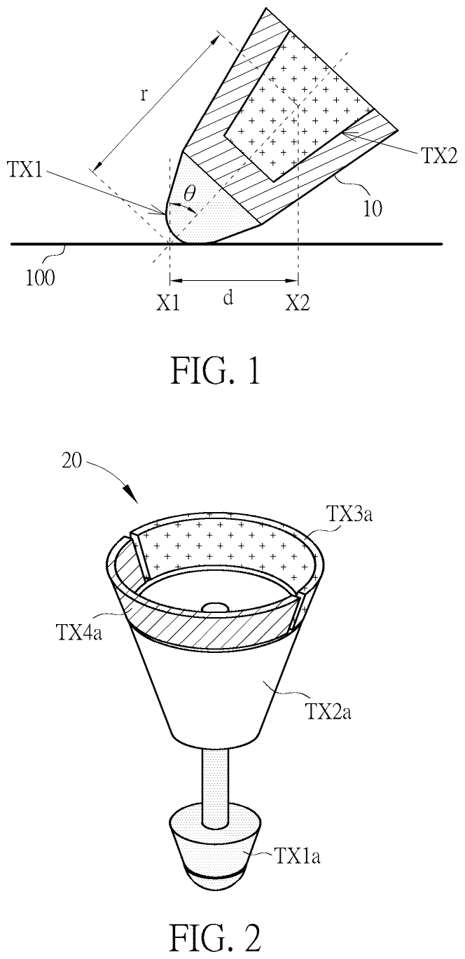

FIG. 2 is a schematic diagram of a stylus 20 according to an embodiment of the present invention. The stylus 20 includes transmission electrodes TX1a-TX4a. The transmission electrodes TX1a and TX2a are similar to the transmission electrodes TX1 and TX2 included in the active stylus 10 as shown in FIG. 1, and may be cooperatively used for tilt detection. Two independent transmission electrodes TX3a and TX4a are additionally deployed in the stylus 20 to perform spin detection. In this embodiment, the transmission electrodes TX3a and TX4a may be half-ring electrodes deployed at opposite sides of the pen axis, and the combination of the transmission electrodes TX3a and TX4a may form an entire ring. In order to optimize the pin detection performance, the transmission electrodes TX3a and TX4a may be symmetric with respect to the pen axis of the stylus 20. Based on the relative position of the transmission electrodes TX3a and TX4a over a period of time (e.g., by detecting the coordinates of the transmission electrodes TX3a and TX4a projected on the touch panel), the touch panel (or its control circuit) may determine whether the stylus 20 is rotating and obtain its rotational direction and speed.

FIG. 2 illustrates the arrangement of the transmission electrodes TX1a-TX4a which may be deployed on the pen head of the stylus 20. Note that the stylus of the present invention may further include other components, such as internal circuits, wire connections, detectors, fixing elements, pen shell, or other necessary elements, which are omitted in FIG. 2 and the following figures without influencing the illustrations of the embodiments.

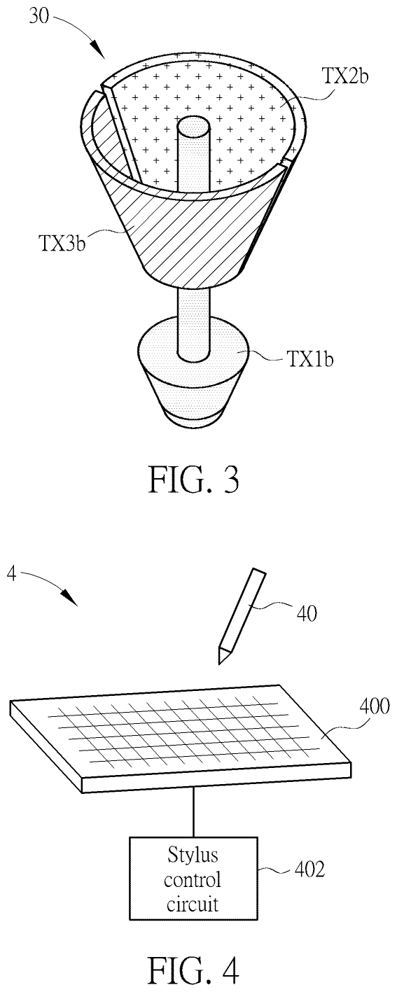

FIG. 3 is a schematic diagram of another stylus 30 according to an embodiment of the present invention. The stylus 30 includes three transmission electrodes TX1b-TX3b only, so as to save the hardware costs. Since the number of transmission electrodes is reduced, the tilt detection and spin detection functions may be integrated in the same transmission electrodes with appropriate control.

As shown in FIG. 3, the transmission electrode TX1b is deployed on the tip of the stylus 30, similar to the transmission electrode TX1a included in the stylus 20 as described above. The transmission electrodes TX2b and TX3b are deployed on the pen body, and at opposite sides of the pen axis. In such a situation, the transmission electrodes TX2b and TX3b may serve as two independent transmission electrodes to perform spin detection. The transmission electrodes TX2b and TX3b may also be merged to perform tilt detection in conjunction with the tip transmission electrode TX1b. In other words, the touch panel (or its control circuit) may perform spin detection based on the relative position of the transmission electrodes TX2b and TX3b, and perform tilt detection based on the relative position between the transmission electrode TX1b and at least one of the transmission electrodes TX2b and TX3b.

FIG. 4 is a schematic diagram of a stylus control system 4 according to an embodiment of the present invention. The stylus control system 4 includes a stylus 40, a touch panel 400 and a stylus control circuit 402. The stylus 40 may be any active stylus having transmission electrodes arranged in an appropriate manner to realize the spin detection function, such as the stylus 20 or 30 in the above embodiment. The stylus 40 may contact or hover on the touch panel 400 so it is detectable by the touch panel 400, where the transmission electrodes of the stylus 40 may output downlink signals to be received by the touch panel 400. The touch panel 400 may obtain a signal distribution corresponding to each downlink signal. For example, the touch panel 400 may include an array of sensing electrodes for receiving the downlink signals. The strengths of the downlink signals received by several sensing electrodes may form a signal distribution. The stylus control circuit 402 may obtain the signal distribution from the sensing electrode array of the touch panel 400, to determine the behavior of the stylus 40 accordingly. In various embodiments, the sensing electrode array may be formed by touch sensing electrodes of the touch panel 400, where the touch sensing electrodes may be used for finger touch sensing in a touch period, and used for stylus sensing in a stylus period.

Referring to FIG. 4 along with FIG. 3, supposing that the stylus 40 has a transmission electrode arrangement identical to the stylus 30 which has the transmission electrodes TX1b-TX3b, the stylus 40 may have a first transmission electrode (e.g., TX2b) which sends a first downlink signal and a second transmission electrode (e.g., TX3b) which sends a second downlink signal. A first signal distribution corresponding to the first downlink signal may be generated on the sensing electrodes of the touch panel 400 when the touch panel 400 receives the first downlink signal, and a second signal distribution corresponding to the second downlink signal may be generated on the sensing electrodes of the touch panel 400 when the touch panel 400 receives the second downlink signal. The first signal distribution and the second signal distribution are then sent to the stylus control circuit 402, and the stylus control circuit 402 may detect the spin of the stylus 40 accordingly.

In an exemplary embodiment, the first downlink signal output by the first transmission electrode (e.g., TX2b) and the second downlink signal output by the second transmission electrode (e.g., TX3b) may be combined to generate a third signal distribution on the touch panel 400, and a third downlink signal output by a third transmission electrode (e.g., TX1b) may generate a fourth signal distribution on the touch panel 400. Therefore, the relative strength of the third signal distribution and the fourth signal distribution may change in response to the tilt of the stylus 30, and the stylus control circuit 402 may detect the tilt angle of the stylus 40 accordingly.

Therefore, based on the arrangement of transmission electrodes of the stylus 30, the transmission electrodes TX2b and TX3b may be used for tilt detection and also used for spin detection, which means that the tilt detection and spin detection are integrated in the same transmission electrodes TX2b and TX3b. In such a situation, the tilt detection and spin detection may be performed time-divisionally, to be realized in the stylus control system 4.

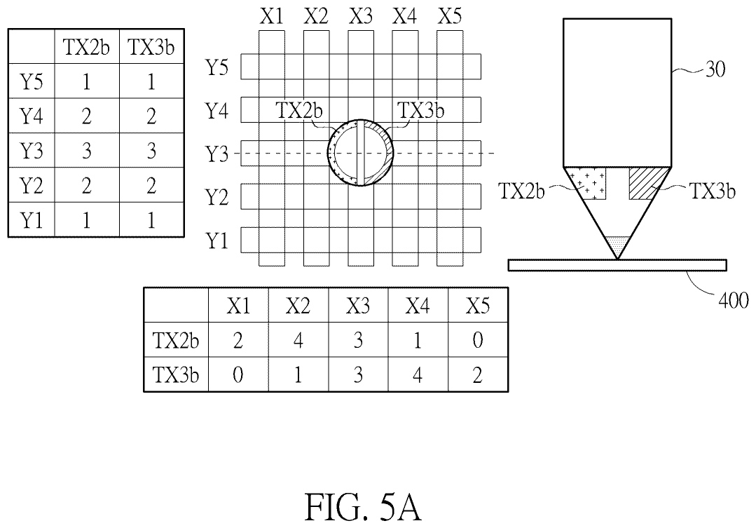

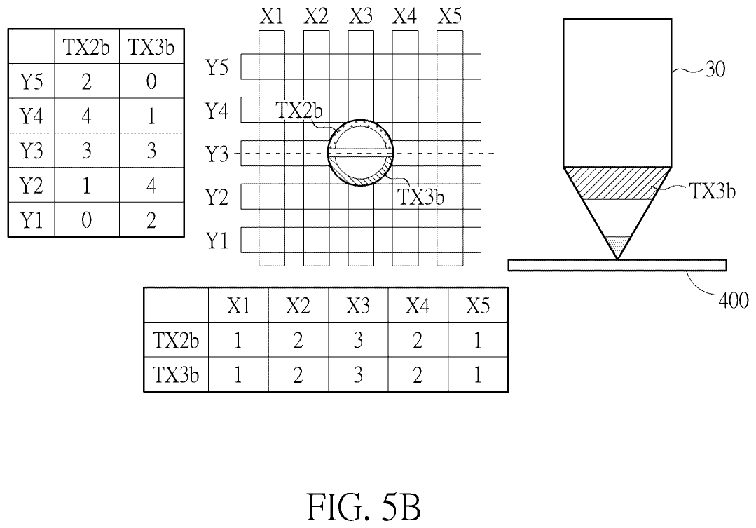

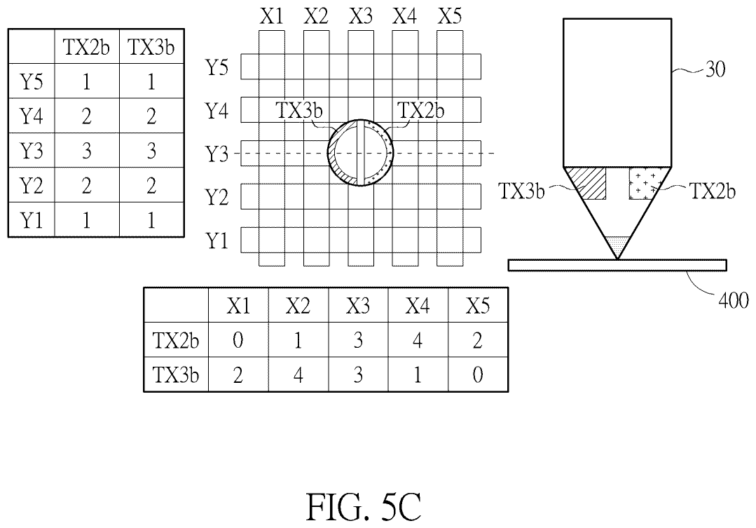

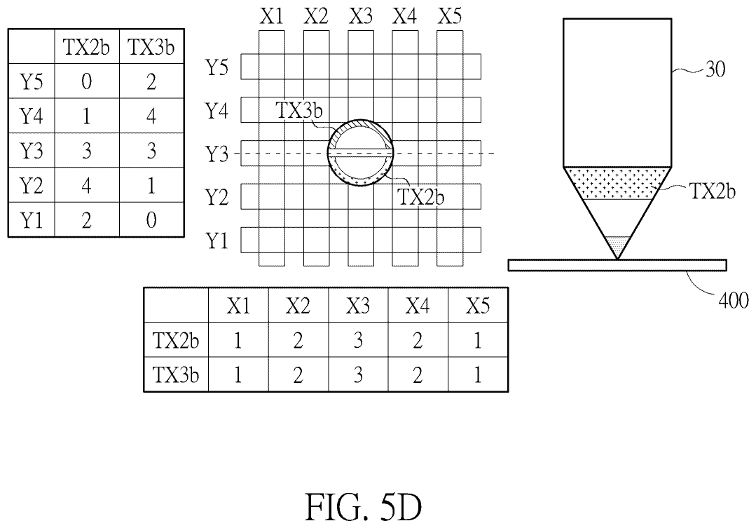

The principle of spin detection of the stylus is described as follows. FIGS. 5A-5D illustrate that the stylus 30 standing on the touch panel 400 rotates to generate different signal distributions according to an embodiment of the present invention, where a side view of the stylus 30 and a top view of the touch panel 400 are shown. During the sensing operation for the stylus 30, the touch sensing electrodes on the touch panel 400 may be merged to form several stylus sensing electrodes X1-X5 arranged along the horizontal direction (X-direction) and several stylus sensing electrodes Y1-Y5 arranged along the vertical direction (Y-direction). In detail, the touch panel 400 may perform stylus sensing by scanning the electrodes in the vertical direction and horizontal direction alternately. When the touch panel 400 scans in the horizontal direction, several or all touch sensing electrodes in the same column may be merged to form a stylus sensing electrode, thereby generating the stylus sensing electrodes X1-X5. When the touch panel 400 scans in the vertical direction, several or all touch sensing electrodes in the same row may be merged to form a stylus sensing electrode, thereby generating the stylus sensing electrodes Y1-Y5. Several or all of the stylus sensing electrodes X1-X5 and Y1-Y5 may obtain a signal distribution generated from the downlink signal sent by the transmission electrode TX2b, and also obtain a signal distribution generated from the downlink signal sent by the transmission electrode TX3b. The values (e.g., from 0 to 4) may be the raw data of the signal distribution, which stand for the signal strength received by each electrode. In this embodiment, it is supposed that the stylus 30 stands on the center of the touch panel 400 without tilting, where the center is the intersection of the stylus sensing electrodes X3 and Y3.

FIG. 5A illustrates that the stylus 30 rotates to a state where the transmission electrode TX2b is at the left side and the transmission electrode TX3b is at the right side. In such a situation, as for vertical (Y-direction) scan, the stylus sensing electrode Y3 has the maximum signal strength corresponding to both the transmission electrodes TX2b and TX3b, and the signal strength falls gradually and symmetrically toward two sides of the stylus sensing electrode Y3. As for horizontal (X-direction) scan, the stylus sensing electrode X2 has the maximum signal strength corresponding to the transmission electrode TX2b since the transmission electrode TX2b is at the left side, and the stylus sensing electrode X4 has the maximum signal strength corresponding to the transmission electrode TX3b since the transmission electrode TX3b is at the right side.

FIG. 5B illustrates that the stylus 30 rotates to a state where the transmission electrode TX2b is at the front side and the transmission electrode TX3b is at the back side, i.e., the stylus 30 has a 90-degree clockwise rotation relative to the state in FIG. 5A. In such a situation, as for horizontal scan, the stylus sensing electrode X3 has the maximum signal strength corresponding to both the transmission electrodes TX2b and TX3b, and the signal strength falls gradually and symmetrically toward two sides of the stylus sensing electrode X3. As for vertical scan, the stylus sensing electrode Y4 has the maximum signal strength corresponding to the transmission electrode TX2b since the transmission electrode TX2b is at the front side, and the stylus sensing electrode Y2 has the maximum signal strength corresponding to the transmission electrode TX3b since the transmission electrode TX3b is at the back side.

FIG. 5C illustrates that the stylus 30 rotates to a state where the transmission electrode TX2b is at the right side and the transmission electrode TX3b is at the left side, i.e., the stylus 30 has a 90-degree clockwise rotation relative to the state in FIG. 5B. In such a situation, as for vertical scan, the stylus sensing electrode Y3 has the maximum signal strength corresponding to both the transmission electrodes TX2b and TX3b, and the signal strength falls gradually and symmetrically toward two sides of the stylus sensing electrode Y3. As for horizontal scan, the stylus sensing electrode X4 has the maximum signal strength corresponding to the transmission electrode TX2b since the transmission electrode TX2b is at the right side, and the stylus sensing electrode X2 has the maximum signal strength corresponding to the transmission electrode TX3b since the transmission electrode TX3b is at the left side.

FIG. 5D illustrates that the stylus 30 rotates to a state where the transmission electrode TX2b is at the back side and the transmission electrode TX3b is at the front side, i.e., the stylus 30 has a 90-degree clockwise rotation relative to the state in FIG. 5C. In such a situation, as for horizontal scan, the stylus sensing electrode X3 has the maximum signal strength corresponding to both the transmission electrodes TX2b and TX3b, and the signal strength falls gradually and symmetrically toward two sides of the stylus sensing electrode X3. As for vertical scan, the stylus sensing electrode Y2 has the maximum signal strength corresponding to the transmission electrode TX2b since the transmission electrode TX2b is at the back side, and the stylus sensing electrode Y4 has the maximum signal strength corresponding to the transmission electrode TX3b since the transmission electrode TX3b is at the front side.

As can be seen, the relative strength of the signal distribution generated from the transmission electrode TX2b and the signal distribution generated from the transmission electrode TX3b may change in response to the spin/rotation of the stylus 30. The stylus control circuit 402 may perform spin detection on the stylus 30 according to the variations of the signal distributions.

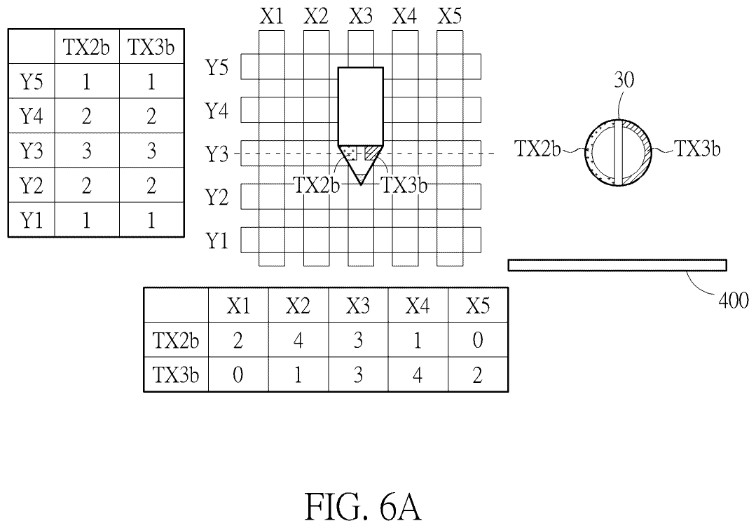

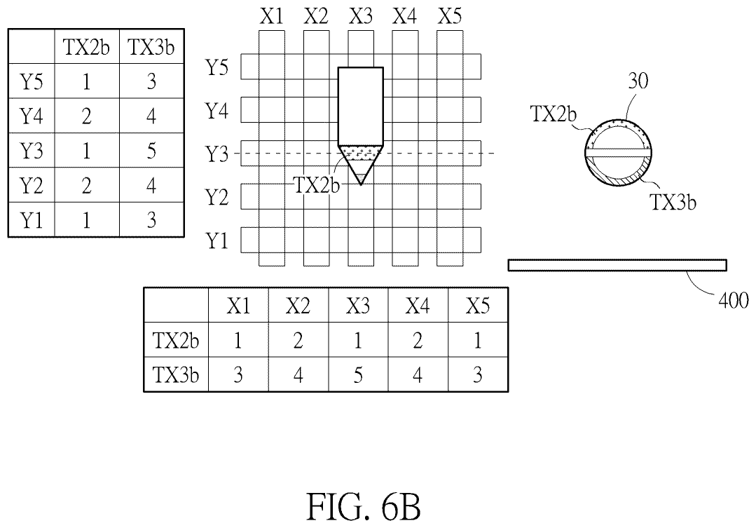

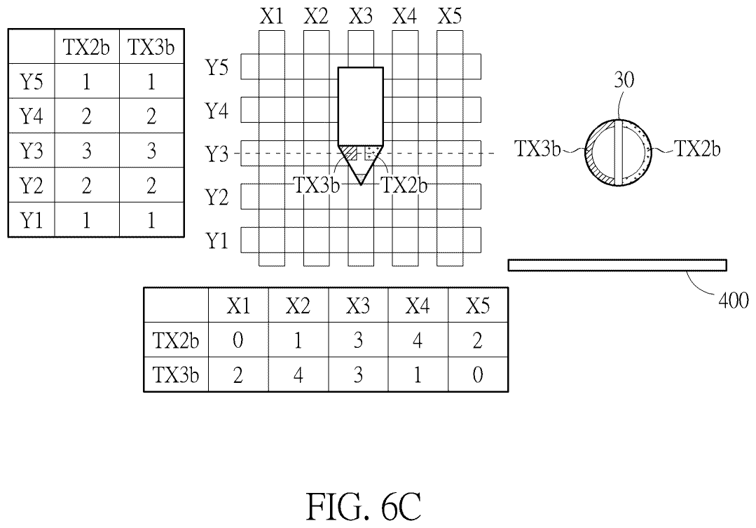

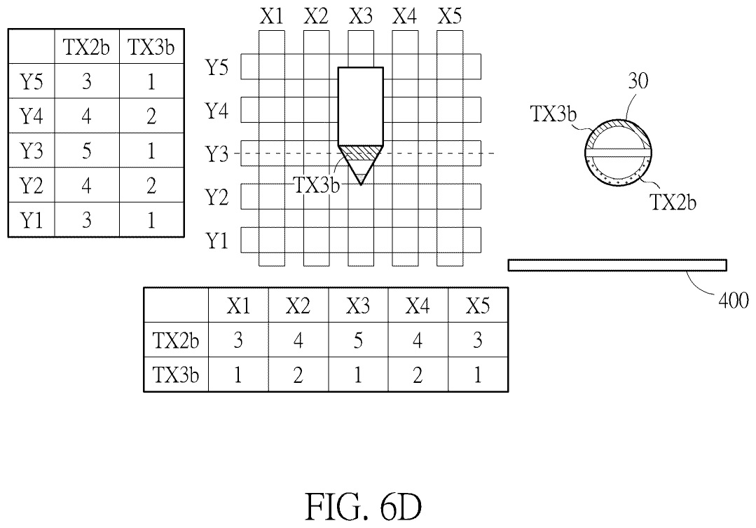

FIGS. 6A-6D illustrate that the stylus 30 hovering on the touch panel 400 rotates to generate different signal distributions according to an embodiment of the present invention, where a side view of the transmission electrodes TX2b and TX3b of the stylus 30 and a top view of the touch panel 400 are shown. In this embodiment, it is supposed that the stylus 30 hovers in parallel with the touch panel 400, with the transmission electrodes TX2b and TX3b approximately over the center of the touch panel 400.

FIG. 6A illustrates that the stylus 30 rotates to a state where the transmission electrode TX2b is at the left side and the transmission electrode TX3b is at the right side. In such a situation, as for vertical scan, the stylus sensing electrode Y3 has the maximum signal strength corresponding to both the transmission electrodes TX2b and TX3b, and the signal strength falls gradually and symmetrically toward two sides of the stylus sensing electrode Y3. As for horizontal scan, the stylus sensing electrode X2 has the maximum signal strength corresponding to the transmission electrode TX2b since the transmission electrode TX2b is at the left side, and the stylus sensing electrode X4 has the maximum signal strength corresponding to the transmission electrode TX3b since the transmission electrode TX3b is at the right side.

FIG. 6B illustrates that the stylus 30 rotates to a state where the transmission electrode TX2b is at the top and the transmission electrode TX3b is at the bottom, i.e., the stylus 30 has a 90-degree clockwise rotation relative to the state in FIG. 6A. In such a situation, the signal strength corresponding to the transmission electrode TX3b received by each of the stylus sensing electrodes X1-X5 and Y1-Y5 is greater than the signal strength corresponding to the transmission electrode TX2b. This is because the transmission electrode TX3b is closer to the touch panel 400 than the transmission electrode TX2b.

FIG. 6C illustrates that the stylus 30 rotates to a state where the transmission electrode TX2b is at the right side and the transmission electrode TX3b is at the left side, i.e., the stylus 30 has a 90-degree clockwise rotation relative to the state in FIG. 6B. In such a situation, as for vertical scan, the stylus sensing electrode Y3 has the maximum signal strength corresponding to both the transmission electrodes TX2b and TX3b, and the signal strength falls gradually and symmetrically toward two sides of the stylus sensing electrode Y3. As for horizontal scan, the stylus sensing electrode X4 has the maximum signal strength corresponding to the transmission electrode TX2b since the transmission electrode TX2b is at the right side, and the stylus sensing electrode X2 has the maximum signal strength corresponding to the transmission electrode TX3b since the transmission electrode TX3b is at the left side.

FIG. 6D illustrates that the stylus 30 rotates to a state where the transmission electrode TX2b is at the bottom and the transmission electrode TX3b is at the top, i.e., the stylus 30 has a 90-degree clockwise rotation relative to the state in FIG. 6C. In such a situation, the signal strength corresponding to the transmission electrode TX2b received by each of the stylus sensing electrodes X1-X5 and Y1-Y5 is greater than the signal strength corresponding to the transmission electrode TX3b. This is because the transmission electrode TX2b is closer to the touch panel 400 than the transmission electrode TX3b.

In the above embodiment, the stylus 30 may hover in parallel with the touch panel 400. In another embodiment, a stylus may tilt with an angle, and the stylus control circuit may detect the tilt state according to the relative strength of the signal distribution generated from the transmission electrode TX1b and the signal distribution generated from the transmission electrodes TX2b and/or TX3b, while performing spin detection with the above principle. The stylus control circuit may detect the rotational speed and direction of the stylus by detecting the relative position of the transmission electrodes TX2b and TX3b based on the variations of signal distribution received by the stylus sensing electrodes.

In various embodiments of the present invention, the stylus may be detected by setting the downlink signals of different transmission electrodes to have different frequencies and/or transmitting the downlink signals at different times, to realize the integration of spin detection, tilt detection and tip detection. The spin detection refers to detecting the spin/rotation of the stylus. The tilt detection refers to detecting the tilt angle of the stylus. The tip detection refers to detecting the position of the pen tip to determine the writing trajectory of the stylus. The embodiments illustrated in FIGS. 5A-5D and 6A-6D are simplified examples where the stylus is rotating without moving. In practice, a stylus might move, tilt and rotate simultaneously. In such a situation, the stylus control circuit is requested to dynamically analyze the overall behaviors of the stylus based on the obtained signal distribution corresponding to each transmission electrode, so as to obtain the moving trajectory, tilt angle and spin behavior of the stylus. The stylus control circuit may perform various detections on the stylus with the frequency-divisional and/or time-divisional approaches through appropriate algorithms, as described below.

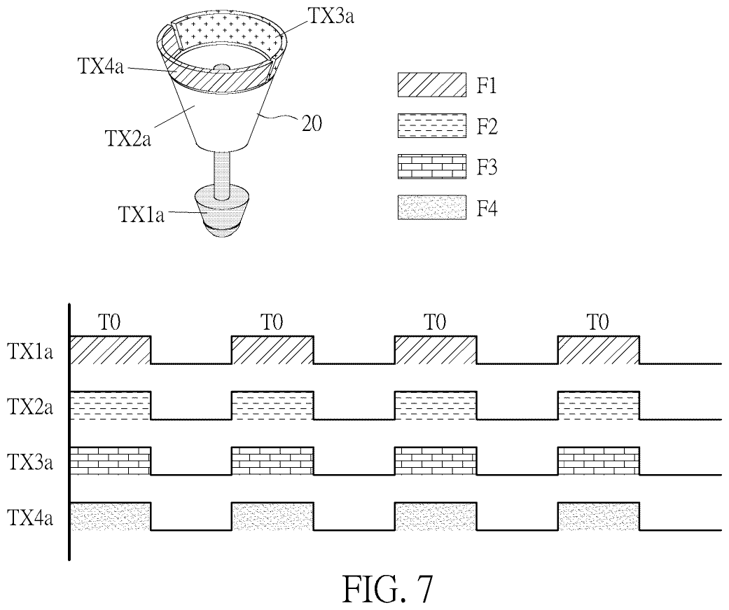

FIG. 7 illustrates the detection of the stylus 20 performed using different frequencies according to an embodiment of the present invention, where the stylus 20 has four transmission electrodes TX1a-TX4a with the arrangement shown in FIG. 2. In detail, the transmission electrode TX1a may output a downlink signal in a frequency F1, the transmission electrode TX2a may output a downlink signal in a frequency F2, the transmission electrode TX3a may output a downlink signal in a frequency F3, and the transmission electrode TX4a may output a downlink signal in a frequency F4. The downlink signals of the transmission electrodes TX1a-TX4a may be output simultaneously in each time slot for stylus sensing (marked as T0). In this embodiment, since the frequencies F1-F4 are all different, they could be output in the same time slot and still distinguishable by the stylus control circuit of the touch panel. In this embodiment, the stylus control circuit is capable of demodulating signals in multiple frequencies, in order to obtain the signal distribution of different frequencies.

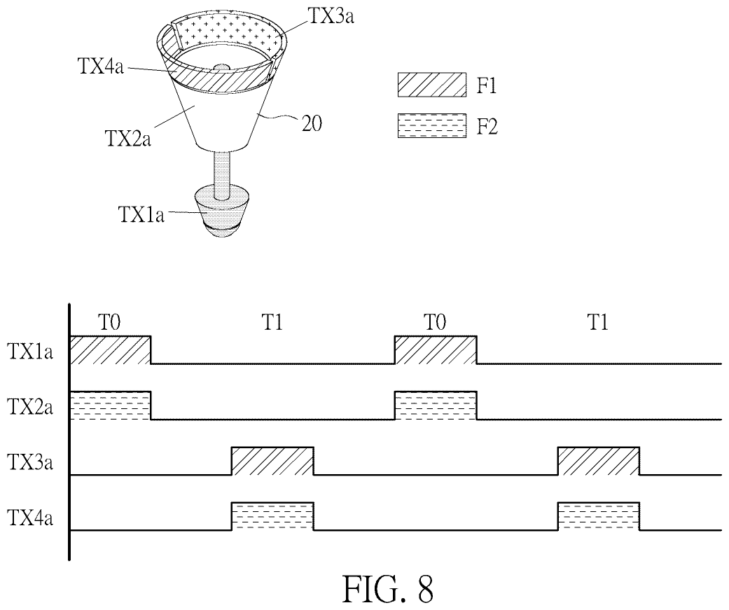

Note that the embodiment shown in FIG. 7 is one of various frequency-divisional implementations of the present invention. In another embodiment, the stylus may apply different numbers of frequencies to output the downlink signals. For example, as shown in FIG. 8, the downlink signals output by the transmission electrodes TX1a and TX3a may be in the frequency F1, and the downlink signals output by the transmission electrodes TX2a and TX4a may be in the frequency F2. In such a situation, the transmission electrodes TX1a and TX2a are configured to output the downlink signals in several time slots (marked as T0), and the transmission electrodes TX3a and TX4a are configured to output the downlink signals in other time slots (marked as T1).

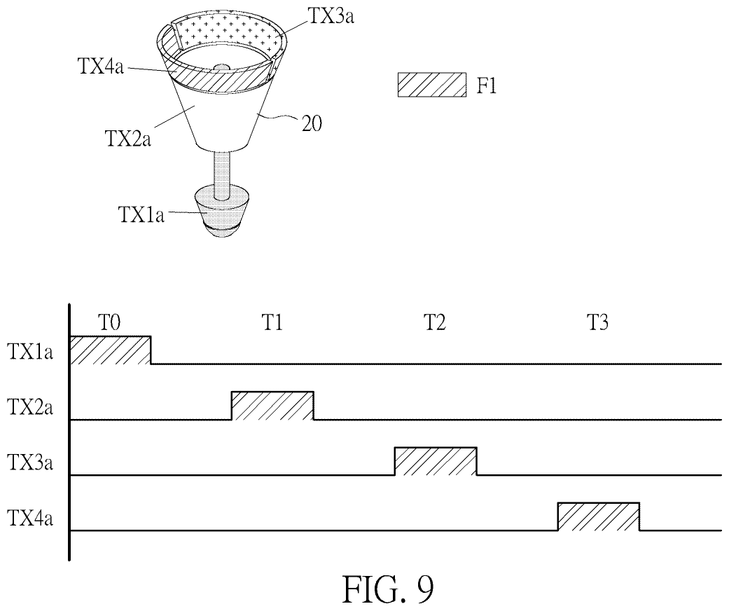

FIG. 9 illustrates the detection of the stylus 20 performed using different timing according to an embodiment of the present invention, where the stylus 20 has four transmission electrodes TX1a-TX4a as the arrangement shown in FIG. 2. In this embodiment, the downlink signals output by the transmission electrodes TX1a-TX4a may be in the same frequency F1. The transmission electrodes TX1a-TX4a may output the downlink signals in different time slots T0-T3, respectively. In such a situation, these downlink signals may still be distinguishable by the stylus control circuit because the stylus control circuit may receive the signal distributions corresponding to different downlink signals in different time slots.

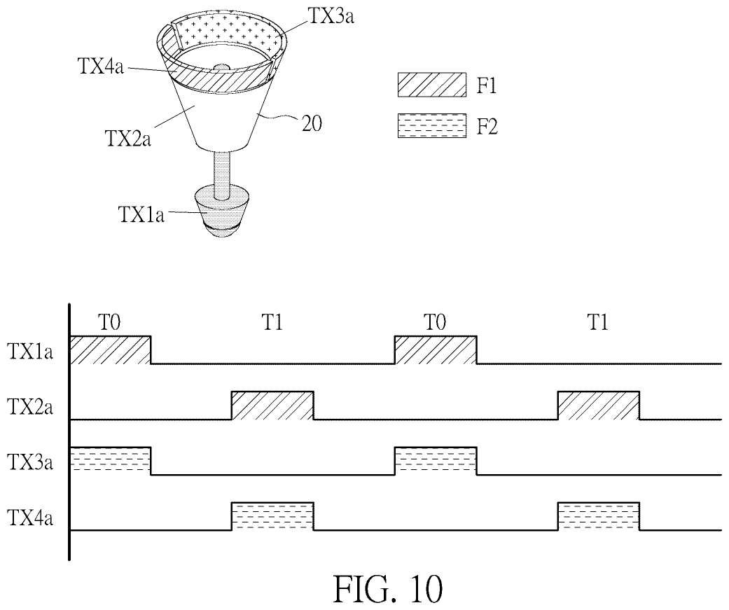

Note that the embodiment shown in FIG. 9 is one of various time-divisional implementations of the present invention. In another embodiment, the time-divisional implementations may be incorporated with multiple frequencies for signal transmissions. For example, as shown in FIG. 10, the downlink signals of the transmission electrodes TX1a and TX3a are output in the time slots T0, and the downlink signals of the transmission electrodes TX2a and TX4a are output in the time slots T1. In such a situation, the downlink signals output by the transmission electrodes TX1a and TX3a may be in the frequencies F1 and F2, respectively, and the downlink signals output by the transmission electrodes TX2a and TX4a may be in the frequencies F1 and F2, respectively.

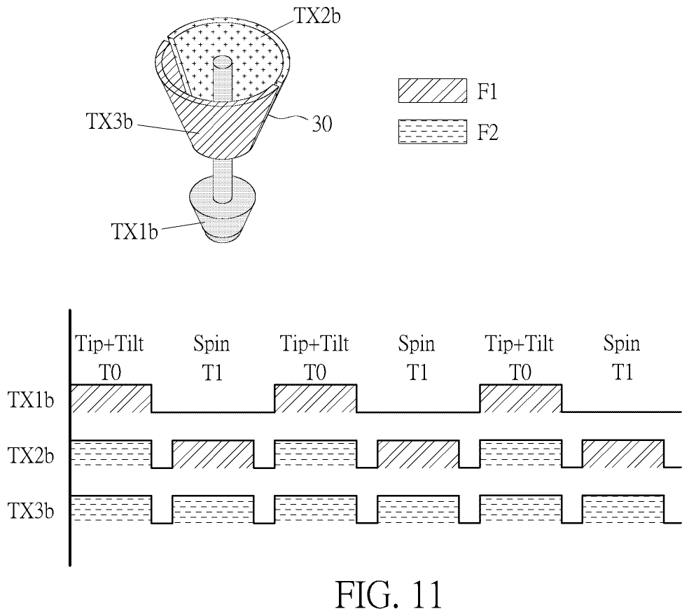

Note that the frequency-divisional and time-divisional approaches may also be applied to the stylus 30 to realize the integration of tilt detection and spin detection. FIG. 11 illustrates the detection of the stylus 30 performed using different frequencies according to an embodiment of the present invention, where the stylus 30 has three transmission electrodes TX1b-TX3b with the arrangement shown in FIG. 3. In this embodiment, the tip, tilt and spin detections may be performed time-divisionally.

In detail, in the time slots T0, the transmission electrode TX1b may output a downlink signal in the frequency F1, and the transmission electrodes TX2b and TX3b may output a downlink signal in the frequency F2. Therefore, the stylus control circuit may perform tip detection based on the signal distribution corresponding to the downlink signal in the frequency F1. The stylus control circuit may also perform tilt detection by detecting the relative position of the transmission electrode TX1b and the transmission electrodes TX2b and TX3b, which may be obtained by detecting the signal distribution in the frequency F1 (which corresponds to the tip electrode TX1b) and detecting the signal distribution in the frequency F2 (which corresponds to the merging of the ring electrodes TX2b and TX3b).

In addition, in the time slots T1, the transmission electrode TX2b may output a downlink signal in the frequency F1, and the transmission electrode TX3b may output a downlink signal in the frequency F2. Therefore, the stylus control circuit may perform spin detection by detecting the relative position of the transmission electrodes TX2b and TX3b, which may be obtained by detecting the signal distribution in the frequency F1 (which corresponds to the transmission electrode TX2b) and detecting the signal distribution in the frequency F2 (which corresponds to the transmission electrode TX3b). The transmission electrode TX1b may stop outputting signals, as shown in FIG. 11. Alternatively, the transmission electrode TX1b may be configured to have another usage in the time slots T1 without affecting the spin detection.

In such a situation, the transmission electrodes TX2b and TX3b may output downlink signals in the same frequency in a first time slot (e.g., T0), and output downlink signals in different frequencies in a second time slot (e.g., T1). Through the frequency arrangements, the transmission electrodes TX2b and TX3b may be used for tip and tilt detections in the time slots T0 and used for spin detection in the time slots T1, so as to realize the integration of various stylus detection operations.

In addition, according to the frequency-divisional implementation of the present invention, at least one of the transmission electrodes used for spin detection may be switched between different output frequencies periodically in a series of time slots for downlink stylus transmission. The frequency change may be predetermined through negotiations between the stylus and the touch panel performed before the downlink transmission starts. In this embodiment, the transmission electrode TX2b is preconfigured to output downlink signals in the frequency F1 in the time slots T1 and output downlink signals in the frequency F2 in the time slots T0. Such a frequency change behavior is predetermined, and is different from the conventional frequency hopping performed based on dynamic noise detection on the associated frequencies. In another embodiment, the frequency change may be operated by the transmission electrode TX3b, or operated by both the transmission electrodes TX2b and TX3b, where the detailed operations of frequency switching should not limit the scope of the present invention.

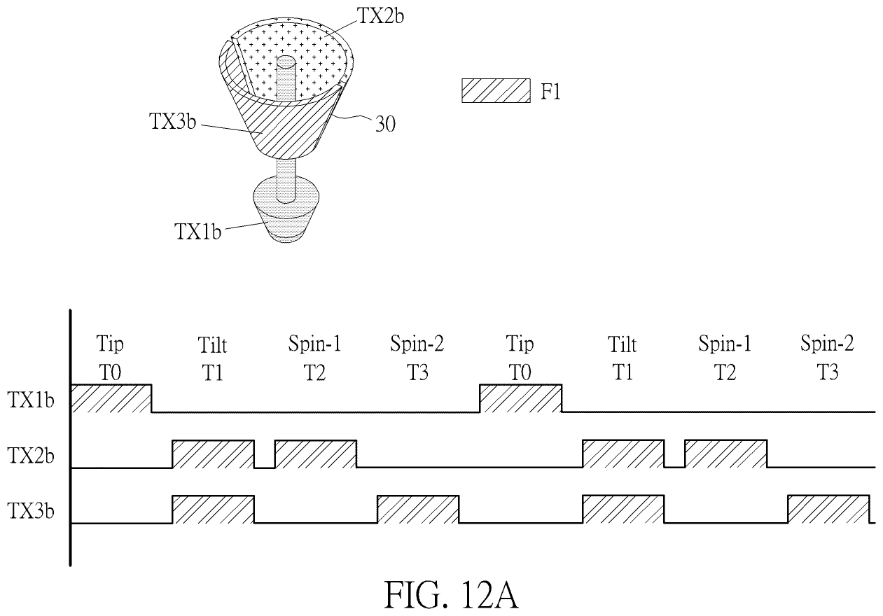

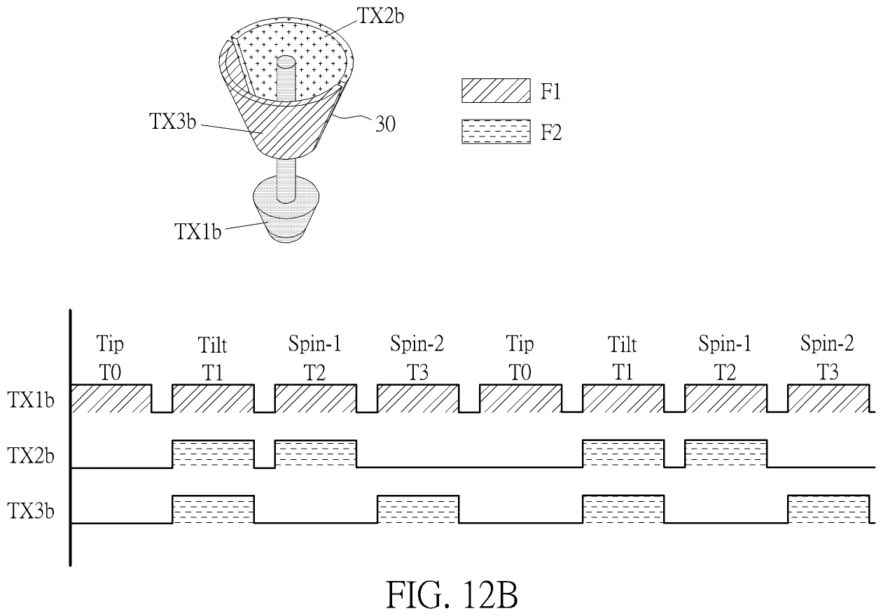

In the above embodiment, the integration of stylus detections is implemented by using multiple frequencies to perform a frequency-divisional operation. Note that the integration of stylus detections may also be implemented in another manner, such as a time-divisional operation. FIG. 12A illustrates the detection of the stylus 30 performed using different timing according to an embodiment of the present invention, where the stylus 30 has three transmission electrodes TX1b-TX3b with the arrangement shown in FIG. 3. In this embodiment, the tip, tilt and spin detections may be performed time-divisionally, and only one frequency is used to transmit the downlink signals.

In detail, the downlink signal of the transmission electrode TX1b is output in the time slots T0. Since the transmission electrode TX1b is a tip electrode, the stylus control circuit may perform tip detection by receiving the downlink signal in the time slots T0.

The downlink signals of the transmission electrodes TX2b and TX3b are output in the time slots T1. Therefore, by detecting the signal distribution corresponding to the downlink signal received in the time slot T0 (which corresponds to the tip electrode TX1b) and detecting the signal distribution corresponding to the downlink signal received in the time slot T1 (which corresponds to the merging of the ring electrodes TX2b and TX3b), the stylus control circuit may perform tilt detection.

Subsequently, the downlink signal of the transmission electrode TX2b is also output in the time slots T2, and the downlink signal of the transmission electrode TX3b is also output in the time slots T3. Therefore, by detecting the signal distribution corresponding to the downlink signal received in the time slot T2 (which corresponds to the transmission electrode TX2b) and detecting the signal distribution corresponding to the downlink signal received in the time slot T3 (which corresponds to the transmission electrode TX3b), the stylus control circuit may perform spin detection.

In such a situation, the transmission electrode TX2b may output downlink signals in the time slots T1 and T2. The transmission electrode TX3b may output a downlink signal in the time slots T1 in which the downlink signal of the transmission electrode TX2b is also output, and output a downlink signal in the time slots T3 where no downlink signal of the transmission electrode TX2b is output. In this embodiment, although only one frequency is utilized, the transmission electrodes TX2b and TX3b may still be used for tilt detection in the time slot T1 and used for spin detection in the time slots T2 and T3 through appropriate timing arrangements, so as to realize the integration of various stylus detection operations.

In other words, according to the time-divisional implementation of the present invention, several transmission electrodes used for spin detection may simultaneously output downlink signals in the same time slot, and also output downlink signals in respective time slots. Similarly, the timing of outputting the downlink signals is predetermined through negotiations between the stylus and the touch panel performed before the downlink transmission starts, and the transmissions may be periodic in a series of time slots.

Note that the time-divisional implementation may further be integrated with the frequency-divisional implementation to realize a more flexible application. For example, FIG. 12B illustrates the detection of the stylus 30 performed using different timing with different frequencies according to an embodiment of the present invention, where the stylus 30 has three transmission electrodes TX1b-TX3b with the arrangement shown in FIG. 3. In this embodiment, the transmission electrode TX1b always outputs downlink signals in a frequency F1, and the transmission electrodes TX2b and TX3b always output downlink signals in another frequency F2. The tilt and spin detection may further be performed time-divisionally; that is, the tilt and spin detection are performed in different time slots.

In detail, the transmission electrode TX1b, which is a tip electrode, may be used to output downlink signals that allow the stylus control circuit to perform tip detection. The tip detection may be performed in any of the time slots T0-T3, where the stylus control circuit may perform tip detection by detecting the signal distribution corresponding to the downlink signals in the frequency F1. In this embodiment, the downlink signals of the transmission electrode TX1b are output in every time slot T0-T3. This operation may enhance the signal strength and increase the reliability of tip detection. In another embodiment, the downlink signals of the transmission electrode TX1b may be output in one or partial time slots. For example, the time slot T0, which is not used for other stylus detection, may be omitted.

The tilt detection may be performed in the time slot T1. In this time slot T1, the transmission electrode TX1b outputs a downlink signal in the frequency F1, and the transmission electrodes TX2b and TX3b output downlink signals in the frequency F2. Therefore, the stylus control circuit may perform tilt detection by detecting the signal distribution corresponding to the downlink signals in the frequency F1 (which corresponds to the tip electrode TX1b and may be in the time slot T1 or any other time slot(s)) and detecting the signal distribution corresponding to the downlink signals in the frequency F2 (which corresponds to the merging of the ring electrodes TX2b and TX3b and are received in the time slot T1).

The spin detection may be performed in the following time slots T2 and T3. In the time slot T2, the transmission electrode TX1b outputs a downlink signal in the frequency F1 and the transmission electrode TX2b outputs a downlink signal in the frequency F2. In the time slot T3, the transmission electrode TX1b outputs a downlink signal in the frequency F1 and the transmission electrode TX3b outputs a downlink signal in the frequency F2. Therefore, the stylus control circuit may perform spin detection by detecting the signal distribution corresponding to the downlink signal in the frequency F2 and received in the time slot T2 (which corresponds to the transmission electrode TX2b) and detecting the signal distribution corresponding to the downlink signal in the frequency F2 and received in the time slot T3 (which corresponds to the transmission electrode TX3b).

In the above embodiments, tip detection is performed in the first time slot T0, tilt detection is performed in the next time slot T1, and spin detection is performed in the following time slots T2 and T3. Note that the present invention is not limited thereto. In another embodiment, the order of these stylus detection operations may be interchanged, and/or the tip detection may be performed in the same time slot(s) with another stylus detection operation. In other words, the integration of tip, tilt and spin detections may be realized in various manners, which should not be limited to those described in this disclosure. In another embodiment, the integration of time-divisional implementation and frequency-divisional implementation may be used to realize more types of stylus detection functions, not limited to the tip, tilt and spin detections.

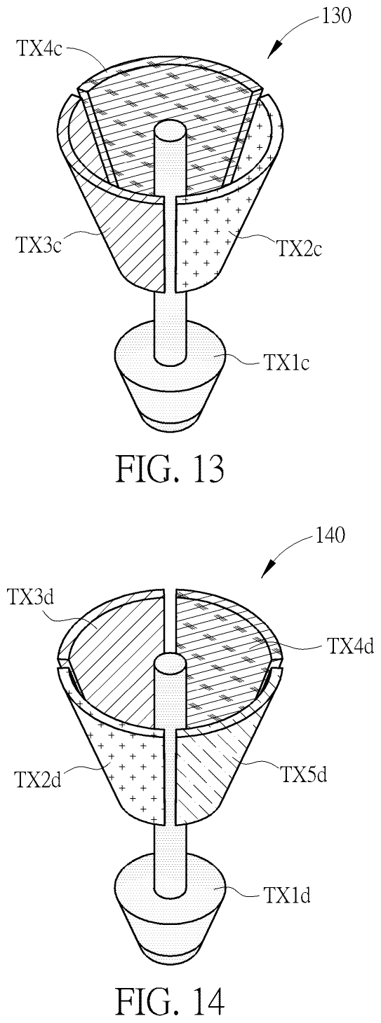

In the above embodiments, there are two ring electrodes deployed at different sides of the pen axis to perform spin detection. In another embodiment, the ring electrodes used for spin detection may have any number. For example, FIG. 13 is a schematic diagram of a stylus 130 according to an embodiment of the present invention. The stylus 130 includes four transmission electrodes TX1c-TX4c, where the transmission electrode TX1c is a tip electrode similar to the transmission electrode TX1a included in the stylus 20 or the transmission electrode TX1b included in the stylus 30. The transmission electrodes TX2c-TX4c are three ring electrodes used for spin detection. More specifically, the transmission electrodes TX2c-TX4c may be partial-ring electrodes symmetrically deployed at different sides of the pen axis, and the combination of the transmission electrodes TX2c-TX4c may form an entire ring. Similarly, the transmission electrodes TX2c-TX4c may be configured to output downlink signals with the same timing/frequency or different timing/frequencies, so as to integrate various stylus detection functions.

FIG. 14 is a schematic diagram of another stylus 140 according to an embodiment of the present invention. The stylus 140 includes five transmission electrodes TX1d-TX5d, where the transmission electrode TX1d is a tip electrode similar to the transmission electrode TX1a included in the stylus 20 or the transmission electrode TX1b included in the stylus 30. The transmission electrodes TX2d-TX5d are four ring electrodes used for spin detection. More specifically, the transmission electrodes TX2d-TX5d may be partial-ring electrodes symmetrically deployed at different sides of the pen axis, and the combination of the transmission electrodes TX2d-TX5d may be configured to output downlink signals with the same timing/frequency or different timing/frequencies, so as to integrate various stylus detection functions.

In fact, there may be any number of transmission electrodes deployed around the stylus, and the implementations are not limited to those described in this disclosure. Also note that the ring electrodes for spin detection may output the same signal or different signals according to system requirements. In an exemplary embodiment, each of the transmission electrodes TX2d-TX5d in the stylus 140 may output different downlink signals. Alternatively, the transmission electrodes TX2d and TX4d may be configured to output the same downlink signal, and the transmission electrodes TX3d and TX5d may be configured to output the same downlink signal.

The touch panel (or its stylus control circuit) of the present invention may perform spin detection to realize various applications. In an embodiment, when the stylus is used to click a functional button on the touch panel, the user may spin the stylus to tune a parameter corresponding to the functional button. For example, when clicking a color control icon, the rotation of the stylus may adjust a color parameter of the displayed image, such as the color depth, contrast degree, or saturation degree. In another embodiment, when clicking a sound control button or bar, the rotation of the stylus may tune the volume. In another embodiment, when clicking a radio icon, the rotation of the stylus may tune the frequency and/or channel.

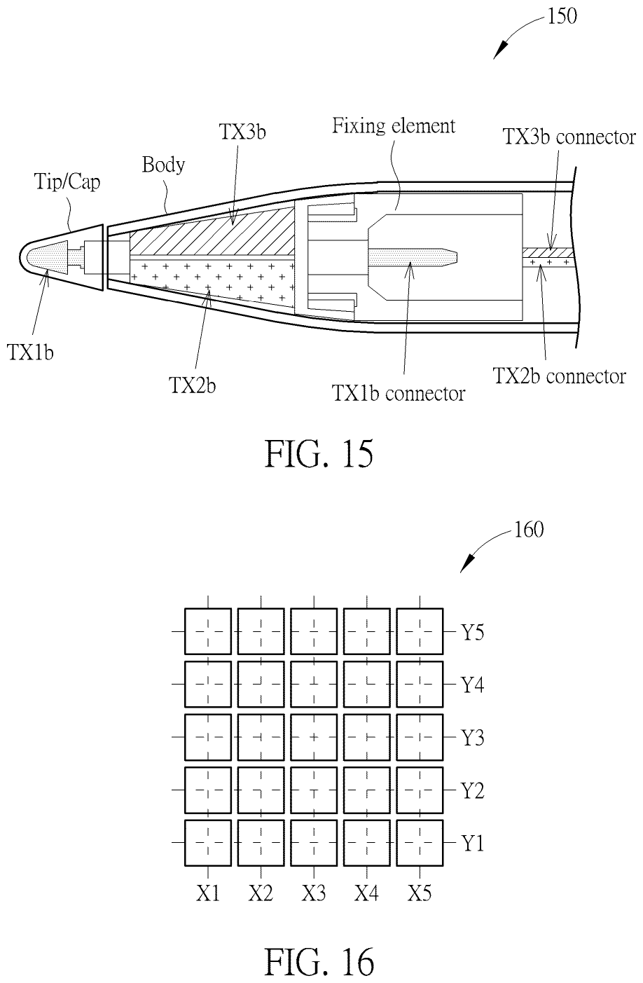

In the above embodiments, only the transmission electrodes of the stylus are illustrated to facilitate the illustrations. The transmission electrodes may be deployed and fixed near the surface, covered by the pen shell, and connected to an internal circuit through a connector, which may be a conducting wire or connecting element. FIG. 15 is a schematic diagram of a stylus 150 according to an embodiment of the present invention, where the stylus 150 has three transmission electrodes TX1b-TX3b arranged as similar to those of the stylus 30 shown in FIG. 3. Note that the transmission electrodes TX1b-TX3b are deployed at the front end (e.g., the pen head part) of the stylus 150, and the stylus 150 may have a long body which is omitted in FIG. 15 for brevity.

In detail, the transmission electrode TX1b may be deployed on the pen tip (or called pen cap) for tip detection. The transmission electrodes TX2b and TX3b may be deployed on the front end of the stylus 150. The stylus 150 may further include a fixing element for fixing the transmission electrodes TX1b-TX3b on the main bone of the stylus 150. In addition, a connector may be connected between each transmission electrode TX1b-TX3b and the main circuit board (not shown) inside the stylus 150.

Note that the present invention aims at providing a novel stylus with transmission electrodes capable of spin detection. Those skilled in the art may make modifications and alterations accordingly. For example, the arrangements of timing and frequency described in this disclosure are merely examples for illustrating the possible spin detection operations. In fact, each transmission electrode may be configured to output a downlink signal having a transmission characteristic, e.g., at a specific time slot with a specific frequency, allowing the touch panel (and/or its stylus control circuit) to differentiate the downlink signals output by different transmission electrodes, and thereby detecting the spin/rotation of the stylus based on the downlink signals of two transmission electrodes deployed at different sides of the pen axis. In another embodiment, the downlink signal may be output with an appropriate encoding scheme, and the stylus control circuit has a corresponding decoding algorithm to decode the data carried in the downlink signal and identify the transmission electrode from which the downlink signal is output.

In addition, the touch panel of the present invention may be any display panel having a touch sensing function and capable of communicating with a stylus. The touch panel may be of any type, such as an organic light emitting diode (OLED) panel or liquid crystal display (LCD) panel, but not limited thereto. The stylus of the present invention may be any type of stylus, which may be an active stylus or unidirectional stylus such as an easy pen. The structure of the touch panel is also not limited, where the on-cell, in-cell, or any other touch panel structure may be applied. Further, the stylus detection schemes of the present invention may be compatible with various touch sensing technologies, which include, but not limited to, self-capacitive touch sensing and mutual capacitive touch sensing, as described below.

FIG. 16 is a schematic diagram of deployment of touch sensing electrodes on a touch panel 160 applying the self-capacitive touch sensing, where the touch sensing electrodes may be merged (i.e., connected) appropriately to form the stylus sensing electrodes for stylus detection. In detail, the touch sensing electrodes may be deployed as an array, which may be merged in different manners in different operation modes. In a first operation mode, the touch sensing electrodes in a column are merged to form a stylus sensing electrode, so as to generate the stylus sensing electrodes X1-X5. In a second operation mode, the touch sensing electrodes in a row are merged to form a stylus sensing electrode, so as to generate the stylus sensing electrodes Y1-Y5. The stylus sensing electrodes X1-X5 and Y1-Y5 may perform the operations shown in FIGS. 5A-5D and 6A-6D to obtain the signal distributions, thereby realizing various stylus detection operations.

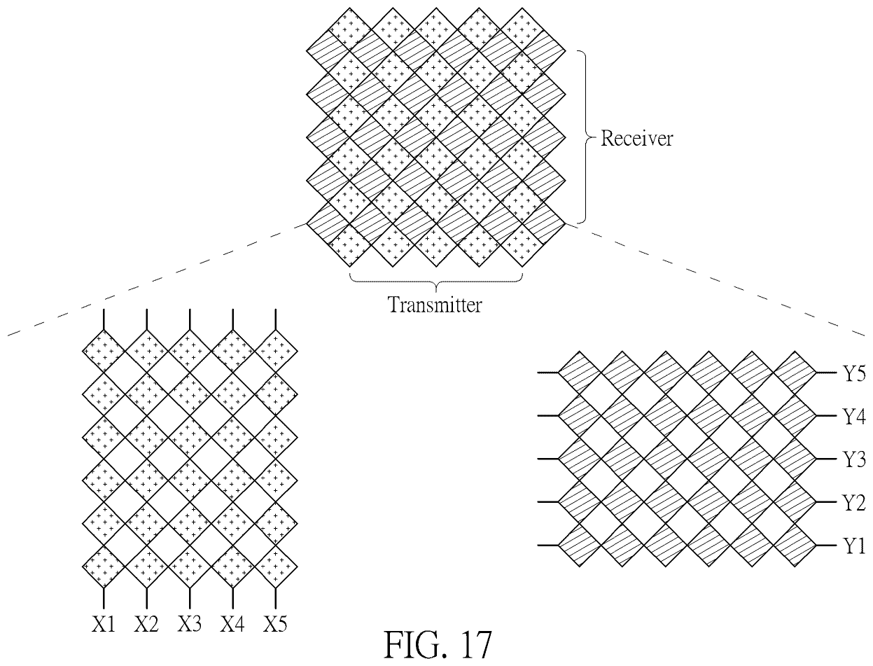

FIG. 17 is a schematic diagram of deployment of touch sensing electrodes on a touch panel 170 applying the mutual capacitive touch sensing, where the touch sensing electrodes may also be merged (i.e., connected) appropriately to form the stylus sensing electrodes for stylus detection. In this embodiment, the touch sensing electrodes include multiple column electrodes connected vertically, which may be used to realize the stylus sensing electrodes X1-X5. The touch sensing electrodes may also include multiple row electrodes connected horizontally, which may be used to realize the stylus sensing electrodes Y1-Y5. In a touch sensing period, the column electrodes may serve as a transmitter and the row electrodes may serve as a receiver, or vice versa, to perform mutual capacitive touch sensing. In a stylus sensing period, the column electrodes (stylus sensing electrodes X1-X5) and the row electrodes (stylus sensing electrodes Y1-Y5) may be used to receive downlink signals of a stylus, to perform the operations shown in FIGS. 5A-5D and 6A-6D to obtain the signal distributions, thereby realizing various stylus detection operations.

In the above embodiments, there are multiple ring electrodes deployed on the pen body to realize spin detection. In another embodiment, the transmission electrodes used for spin detection may be deployed in another manner. For example, the transmission electrodes used for spin detection may be integrated with the tip electrode.

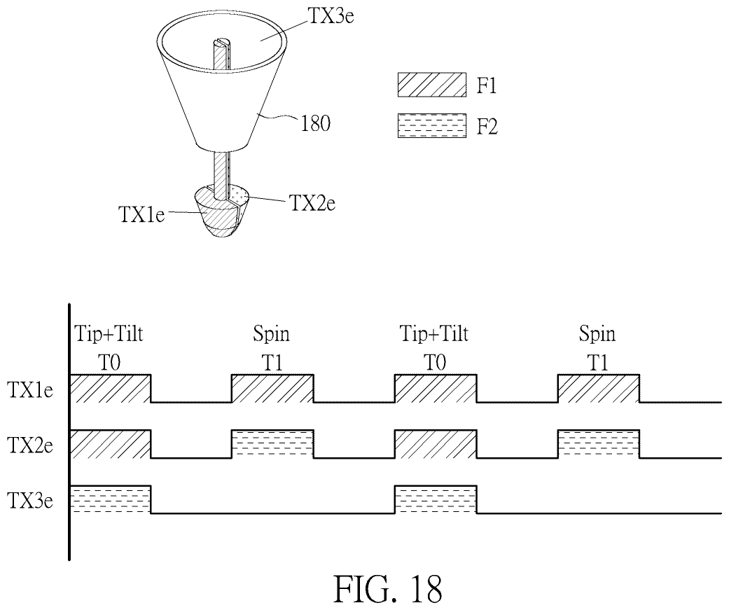

FIG. 18 is a schematic diagram of a stylus 180 with a control scheme according to an embodiment of the present invention. The stylus 180 includes three transmission electrodes TX1e-TX3e. The transmission electrode TX3e is a ring electrode deployed around the pen body. The transmission electrodes TX1e and TX2e are two tip electrodes deployed at the pen tip of the stylus 180. In detail, the transmission electrodes TX1e and TX2e are deployed at different sides of the pen axis of the stylus 180. Preferably, the transmission electrodes TX1e and TX2e are symmetric to each other with respect to the pen axis. Based on the arrangement of transmission electrodes of the stylus 180, the transmission electrodes TX1e and TX2e may be merged to output the same downlink signal to perform tip detection and tilt detection, and may also output different downlink signals to perform spin detection.

As shown in FIG. 18, in the time slots T0, the transmission electrodes TX1e and TX2e may output downlink signals in the frequency F1, and the transmission electrode TX3e may output a downlink signal in the frequency F2. Therefore, the stylus control circuit may perform tip detection based on the signal distribution corresponding to the downlink signals in the frequency F1. The stylus control circuit may also perform tilt detection by detecting the relative position of the transmission electrodes TX1e and TX2e and the transmission electrode TX3e, which may be obtained by detecting the signal distribution in the frequency F1 (which corresponds to the merging of the tip electrodes TX1e and TX2e) and detecting the signal distribution in the frequency F2 (which corresponds to the ring electrode TX3e).

In addition, in the time slots T1, the transmission electrode TX1e may output a downlink signal in the frequency F1, and the transmission electrode TX2e may output a downlink signal in the frequency F2. Therefore, the stylus control circuit may perform spin detection by detecting the relative position of the transmission electrodes TX1e and TX2e, which may be obtained by detecting the signal distribution in the frequency F1 (which corresponds to the transmission electrode TX1e) and detecting the signal distribution in the frequency F2 (which corresponds to the transmission electrode TX2e). The transmission electrode TX3e may stop outputting signals, as shown in FIG. 18. Alternatively, the transmission electrode TX3e may be configured to have another usage in the time slots T1 without affecting the spin detection.

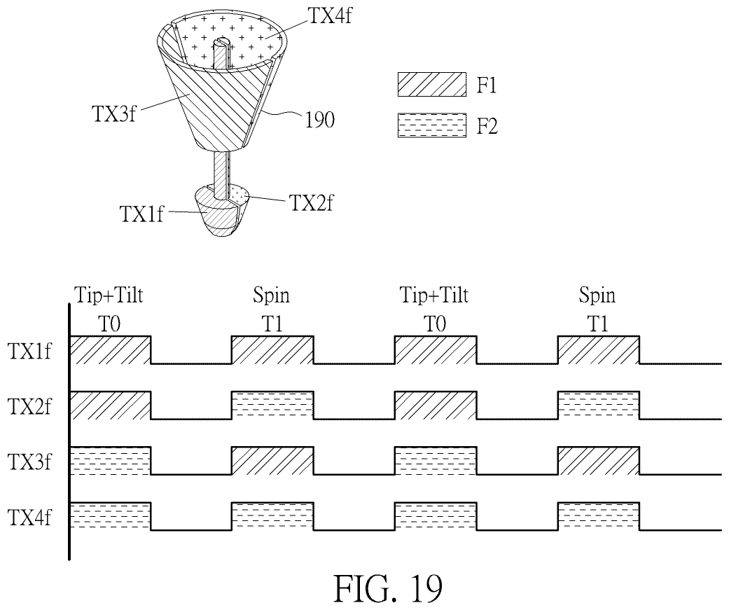

FIG. 19 is a schematic diagram of another stylus 190 with a control scheme according to an embodiment of the present invention. In this embodiment, the transmission electrodes for spin detection are deployed at the pen tip and also at the pen head or pen body. In detail, the stylus 190 includes four transmission electrodes TX1f-TX4f. The transmission electrodes TX1f and TX2f are two tip electrodes deployed at the pen tip, and the transmission TX3f and TX4f are two ring electrodes deployed at the pen head or pen body. The transmission electrodes TX1f and TX2f are deployed at different sides of the pen axis of the stylus 190, and may be symmetric to each other with respect to the pen axis. Similarly, the transmission electrodes TX3f and TX4f are deployed at different sides of the pen axis of the stylus 190, and may be symmetric to each other with respect to the pen axis. In addition, the transmission electrodes TX1f and TX3f may be deployed at the same side of the pen axis, and the transmission electrodes TX2f and TX4f may be deployed at the same side of the pen axis. Based on the arrangement of transmission electrodes of the stylus 190, the spin detection may be performed by merging the transmission electrodes TX1f and TX3f and merging the transmission electrodes TX2f and TX4f. The merging of tip electrode and ring electrode may enhance the signal amount output by the transmission electrodes, thereby improving the stylus sensing performance.

As shown in FIG. 19, in the time slots T0, the transmission electrodes TX1f and TX2f may output downlink signals in the frequency F1, and the transmission electrodes TX3f and TX4f may output downlink signals in the frequency F2. Therefore, the stylus control circuit may perform tip detection based on the signal distribution corresponding to the downlink signals in the frequency F1. The stylus control circuit may also perform tilt detection by detecting the relative position of the transmission electrodes TX1f and TX2f and the transmission electrodes TX3f and TX4f, which may be obtained by detecting the signal distribution in the frequency F1 (which corresponds to the merging of the tip electrodes TX1f and TX2f) and detecting the signal distribution in the frequency F2 (which corresponds to the merging of the ring electrodes TX3f and TX4f).

In addition, in the time slots T1, the transmission electrodes TX1f and TX3f may output downlink signals in the frequency F1, and the transmission electrodes TX2f and TX4f may output downlink signals in the frequency F2. Therefore, the stylus control circuit may perform spin detection by detecting the relative position of the transmission electrodes TX1f and TX3f and the transmission electrodes TX2f and TX4f, which may be obtained by detecting the signal distribution in the frequency F1 (which corresponds to the merging of the transmission electrodes TX1f and TX3f) and detecting the signal distribution in the frequency F2 (which corresponds to the merging of the transmission electrodes TX2f and TX4f).

To sum up, the present invention provides a novel stylus, of which the transmission electrodes may be deployed in an appropriate manner to integrate various stylus detection operations such as tip detection, tilt detection and spin detection. The stylus may include multiple transmission electrodes deployed at different sides of the pen axis. These transmission electrodes may output downlink signals having different transmission characteristics, e.g., at different time slots and/or in different frequencies, allowing the stylus control circuit to perform spin detection by differentiating the downlink signals. In several embodiments, the transmission electrodes may be used for spin detection and tip/tilt detection time-divisionally. The stylus control circuit may be provided with appropriate algorithms to analyze the signal distribution generated from the downlink signals of the transmission electrodes, so as to realize various stylus detection operations. By using the stylus of the present invention, the spin detection may be realized without the usage of a gyroscope.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A stylus comprising:
a plurality of transmission electrodes, comprising:
a first transmission electrode, deployed at a first side of a pen axis of the stylus; and
a second transmission electrode, deployed at a second side of the pen axis of the stylus;
wherein the first side is different from the second side.

2. The stylus of claim 1, wherein the first transmission electrode is symmetric to the second transmission electrode with respect to the pen axis of the stylus.

3. The stylus of claim 1, wherein a relative position of the first transmission electrode and the second transmission electrode changes in response to a spin of the stylus.

4. The stylus of claim 1, wherein a first signal distribution is generated from a first signal output by the first transmission electrode and a second signal distribution is generated from a second signal output by the second transmission electrode, and a relative strength of the first signal distribution and the second signal distribution changes in response to a spin of the stylus.

5. The stylus of claim 1, wherein the pen axis of the stylus is an axis connecting a tip of the stylus and a back end of the stylus.

6. The stylus of claim 1, wherein the plurality of transmission electrodes further comprise:
a third transmission electrode, deployed at a tip of the stylus.

7. The stylus of claim 6, wherein the third transmission electrode and at least one of the first transmission electrode and the second transmission electrode are used for tilt detection of the stylus.

8. The stylus of claim 6, wherein a first signal distribution is generated from a combination of a first signal output by the first transmission electrode and a second signal output by the second transmission electrode and a second signal distribution is generated from a third signal output by the third transmission electrode, and a relative strength of the first signal distribution and the second signal distribution changes in response to a tilt of the stylus.

9. The stylus of claim 6, wherein the plurality of transmission electrodes further comprise:
a fourth transmission electrode, deployed at a body of the stylus;
wherein the third transmission electrode and the fourth transmission electrode are used for tilt detection of the stylus.

10. The stylus of claim 1, wherein the first transmission electrode outputs a first signal and the second transmission electrode outputs a second signal different from the first signal.

11. The stylus of claim 10, wherein the first signal is in a first frequency, and the second signal is in a second frequency different from the first frequency.

12. The stylus of claim 10, wherein the first signal is output in a first time slot, and the second signal is output in a second time slot different from the first time slot.

13. The stylus of claim 1, wherein the first transmission electrode outputs a first signal in a first time slot and outputs a second signal in a second time slot, and the second transmission electrode outputs a third signal in the first time slot and outputs a fourth signal in the second time slot, wherein the first signal and the third signal are in a same frequency, and the second signal and the fourth signal are in different frequencies.

14. The stylus of claim 1, wherein the first transmission electrode outputs a first signal in a first time slot and outputs a second signal in a second time slot, and the second transmission electrode outputs a third signal in the first time slot and outputs a fourth signal in a third time slot different from the second time slot.

15. The stylus of claim 1, wherein at least one of the first transmission electrode and the second transmission electrode is used for tilt detection in a first time slot and used for spin detection in a second time slot.

16. The stylus of claim 1, wherein a parameter is tuned by spinning the stylus.

17. The stylus of claim 16, wherein the parameter comprises at least one of a color parameter of an image, a volume, and a radio channel.

18. The stylus of claim 1, wherein the first transmission electrode and the second transmission electrode are deployed at a tip of the stylus.

19. The stylus of claim 18, wherein the plurality of transmission electrodes further comprise a third transmission electrode and a fourth transmission electrode deployed at a body of the stylus, wherein the third transmission electrode is deployed at the first side of the pen axis of the stylus, and the fourth transmission electrode is deployed at the second side of the pen axis of the stylus.

20. A stylus control circuit for detecting a stylus, the stylus comprising a first transmission electrode and a second transmission electrode, the stylus control circuit being to:
receive a first signal distribution corresponding to a first signal output by the first transmission electrode;
receive a second signal distribution corresponding to a second signal output by the second transmission electrode; and
detect a spin of the stylus according to the first signal distribution and the second signal distribution.

21. The stylus control circuit of claim 20, wherein a relative position of the first transmission electrode and the second transmission electrode changes in response to the spin of the stylus.

22. The stylus control circuit of claim 20, wherein a relative strength of the first signal distribution and the second signal distribution changes in response to the spin of the stylus.

23. The stylus control circuit of claim 20, further being to:
receive a third signal distribution corresponding to a combination of the first signal and the second signal;
receive a fourth signal distribution corresponding to a third signal output by a third transmission electrode of the stylus; and
detect a tilt of the stylus according to the third signal distribution and the fourth signal distribution.

24. The stylus control circuit of claim 20, wherein the first signal is in a first frequency, and the second signal is in a second frequency different from the first frequency.

25. The stylus control circuit of claim 20, wherein the first signal distribution is received in a first time slot, and the second signal distribution is received in a second time slot different from the first time slot.

26. The stylus control circuit of claim 20, wherein the first signal distribution and the second signal distribution are received in a first time slot, and the stylus control circuit is further to:
e a third signal distribution corresponding to a receive combination of a third signal output by the first transmission electrode and a fourth signal output by the second transmission electrode in a second time slot;
wherein the third signal and the fourth signal are in a same frequency, and the first signal and the second signal are in different frequencies.

27. The stylus control circuit of claim 20, wherein the first signal distribution is received in a first time slot and the second signal distribution is received in a second time slot, and the stylus control circuit is further to:
receive a third signal distribution corresponding to a combination of a third signal output by the first transmission electrode and a fourth signal output by the second transmission electrode in a third time slot.

28. The stylus control circuit of claim 20, wherein at least one of the first transmission electrode and the second transmission electrode is used for tilt detection in a first time slot and used for spin detection in a second time slot.

29. The stylus control circuit of claim 20, further being to:
control a parameter to be tuned when the spin of the stylus is detected.

30. The stylus control circuit of claim 29, wherein the parameter comprises at least one of a color parameter of an image, a volume, and a radio channel.
